(19) United States
(12) Patent Application Publication
(10) Pub. No.: US 2019/0186195 A1
(43) Pub. Date: Jun. 20, 2019

(54) BLINDS SAFETY STRING

(71) Applicant: John I. Andersen, Idaho Falls, ID (US)

(72) Inventor: John I. Andersen, Idaho Falls, ID (US)

(21) Appl. No.: 15/847,851

(22) Filed: Dec. 19, 2017

(51) Int. Cl. E06B 9/326

(52) U.S. Cl. CPC E06B 9/326; E06B 2009/785

(57) ABSTRACT

A set of blinds or other window coverings can be made more safe by keeping the pull string out of reach of infants or young children. A safety disc can be secured to the pull string while a safety anchor is secured to a window frame, a door frame, a wall surface near the window covering, or other similar surface. The safety disc and safety anchor are adapted to be removably attaching to one another. In one embodiment, the safety disc and safety anchor each comprise a hook-and-loop attachment surface. In one embodiment, magnets and/or magnetic surfaces are utilized to removably attach the safety disc and safety anchor to each other. In one embodiment, the safety disc comprises a suction cup attachable to a window.

### BACKGROUND

One common potential cause of injury to infants and toddlers is the pull string for blinds and similar window and/or door coverings. Children have been known to inadvertently become tangled in pull strings, which has resulted in serious harm or even death to numerous children.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 depicts a blinds pull string having a safety disc comprising a hook-and-loop surface according to one embodiment of the present disclosure;

FIG. 2 is a detail view of a blinds pull string having a safety disc comprising a hook-and-loop surface according to one embodiment of the present disclosure;

FIG. 3 depicts a blinds safety anchor comprising a hook-and-loop surface according to one embodiment of the present disclosure;

FIG. 4 depicts one potential use of a blinds pull string according to one embodiment of the present disclosure;

FIG. 5 is a detail view of one potential use of a blinds pull string according to one embodiment of the present disclosure;

FIG. 6 depicts a blinds safety anchor comprising a suction cup according to one embodiment of the present disclosure; and

FIG. 7 illustrates one potential use of a blinds safety anchor comprising a suction cup according to one embodiment of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, reference is made to exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples.

Embodiments of the present disclosure include a safety disc attached to a binds pull string and a safety anchor fixed at a point near the blinds pull string, wherein the safety disc and the safety anchor are adapted to removably attach to one another.

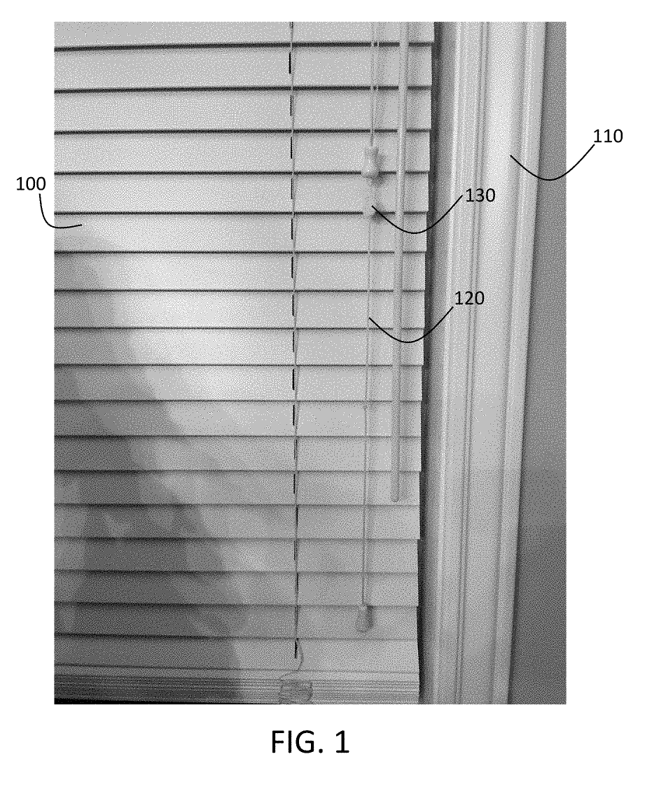

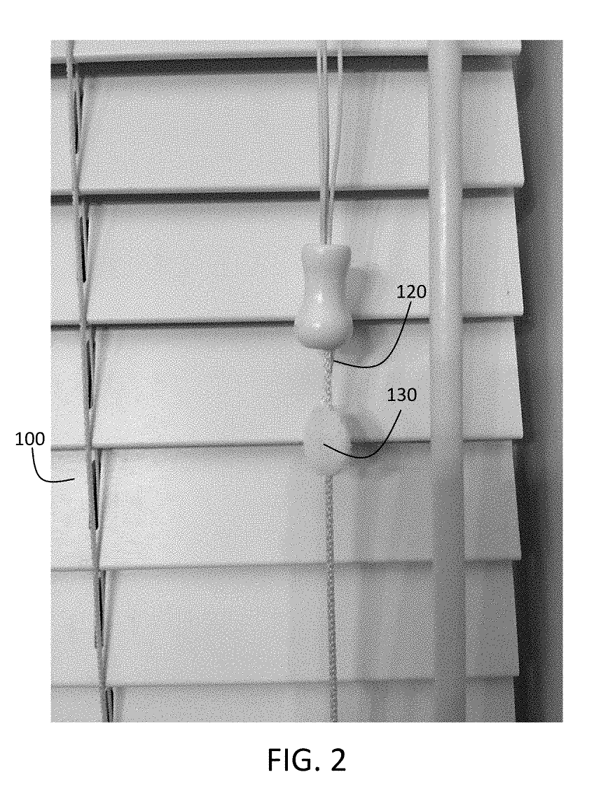

Referring to FIG. 1, a set of blinds 100 is installed to cover a window within a window frame 110. Binds pull string 120 hangs from a retraction assembly of the blinds (not shown). Referring to FIG. 2, safety disc 130 is attached to pull string 120. According to one embodiment, safety disc 130 is a roughly coin-sized circular disc having a hook-and-loop attachment surface.

In another embodiment, a safety disc comprises a magnet or magnetic material. In some embodiments, the safety disc is integrated with a pull drop/tassel 140 on the pull string.

According to various embodiments, safety disc 130 is secured to pull string 120 by an adhesive, by a knot in the pull string 120, by mechanical means such as a crimp, or by other means known in the art. It may be desirable for safety disc 130 to be adapted to not slide along the length of pull string 120, but rather remain fixed at a certain point on pull string 120.

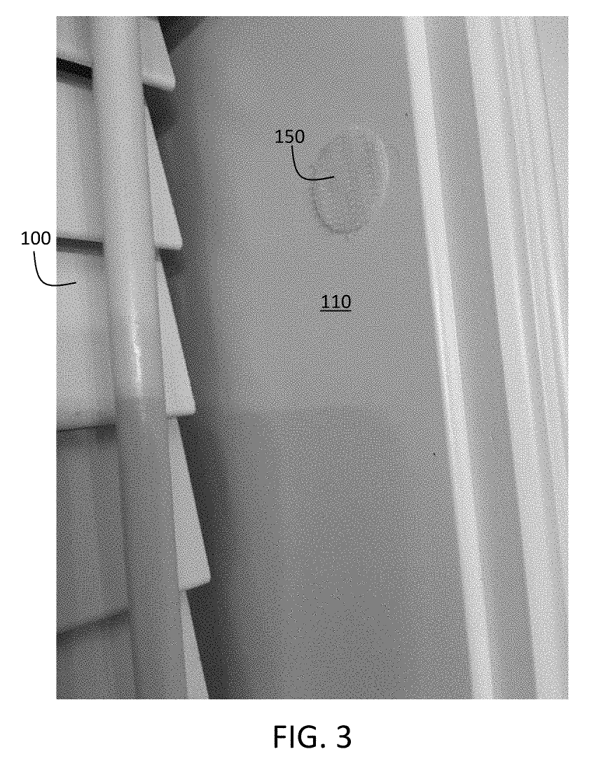

Referring to FIG. 3, safety anchor 150 is fixed to window frame 110. One embodiment of safety anchor 150 comprises a hook-and-loop attachment surface adapted to removable attach to safety disc 130 when pressed together. In another embodiment, safety anchor 150 comprises a magnet or magnetic materials adapted to removably attach to a magnet or magnetic safety disc.

According to various embodiments, safety anchor 150 may be installed at or near the top of window 110. As would be appreciated by a person of ordinary skill in the art having the benefit of this disclosure, safety anchor 150 may be installed at a height that may result in keeping pull string 120 out of reach of children when safety disc 130 is attached to safety anchor 150. Thus, the ideal placement of safety anchor 150 may depend on the height and vertical placement of the particular window, the height of the children living or visiting the location, and the length of pull string 120.

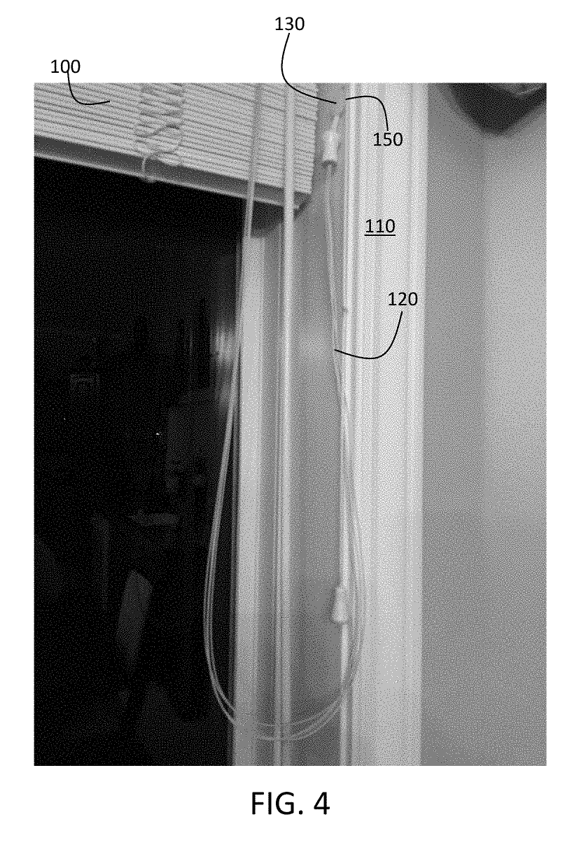

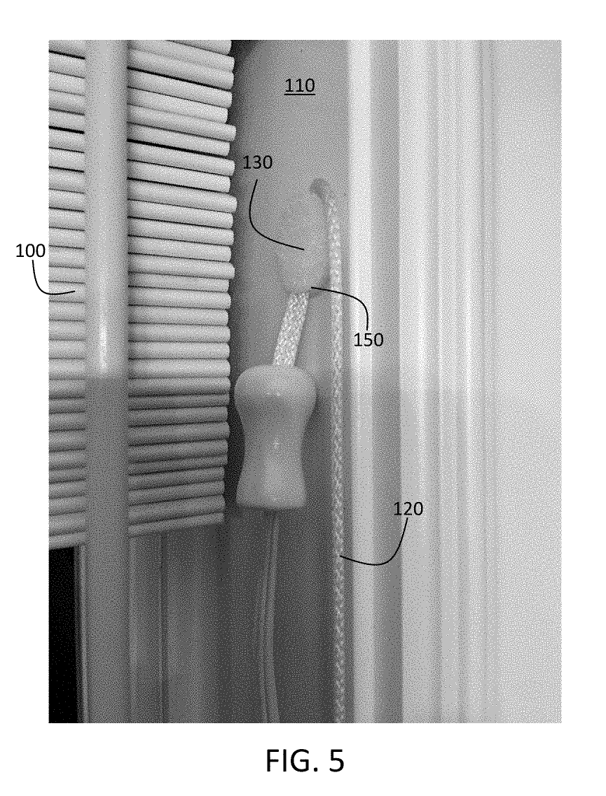

Referring to FIG. 4, safety disc 130 is attached to safety anchor 150, which may keep pull string 120 out of reach of young children. In some cases, attaching safety disc 130 to safety anchor 150 may only be called for when the blinds are open, as many pull strings hang much lower while blinds are open. In other cases, it may be preferred to attach safety disc 130 to safety anchor 150 even while blinds are closed. Referring to FIG. 5, safety disc 130 is secured to safety anchor 150 with enough holding force to prevent unwanted detachment. It may be preferable to take into account the weight of pull string 120 and pull drop/tassel 140 when selecting the specifications of the hook-and-loop surfaces and/or magnets.

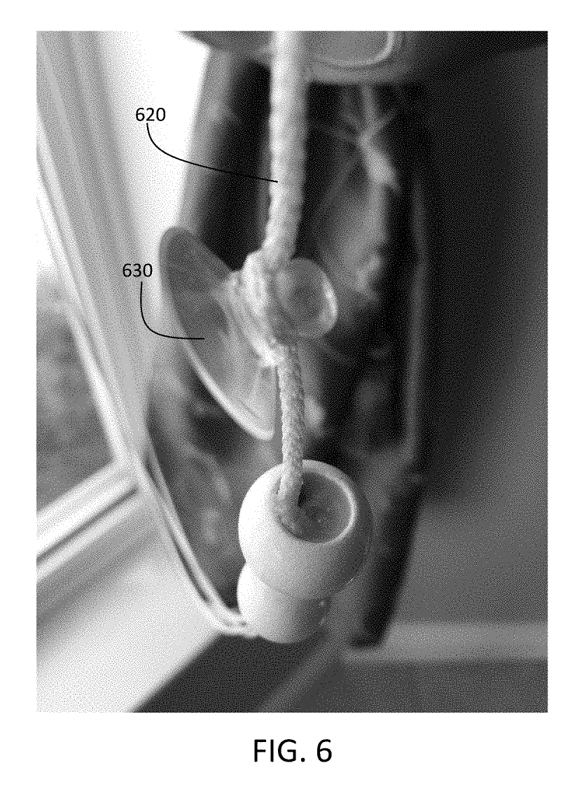

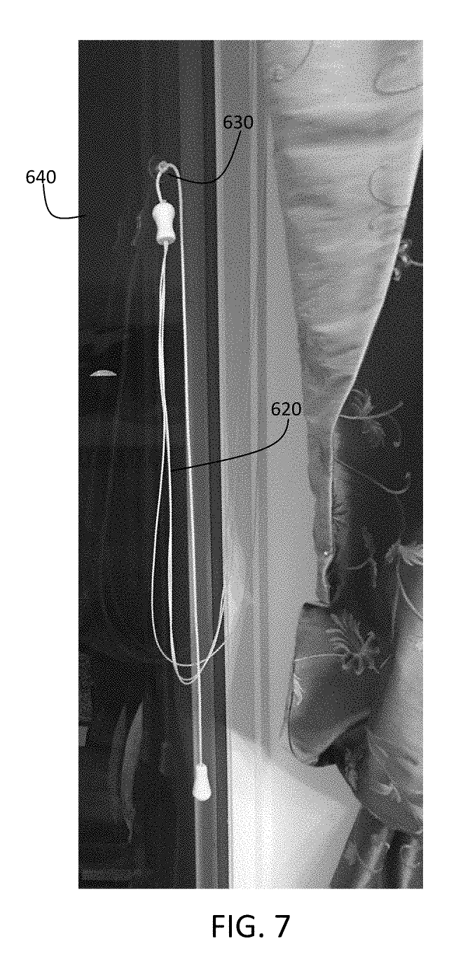

Referring to FIG. 6, some embodiments of the present disclosure include a safety disc that comprises a suction cup 630 secured to pull string 620. Referring to FIG. 7, suction cup 630 is adapted to temporarily adhere to window 640. By placing suction cup 630 at a selectively high location on window, pull string 620 may be kept out of reach from children. Suction cup 630 may be removed from window 640 to lower the blinds or other window covering.

In embodiments of the present disclosure, safety discs can be secured to pull strings at a position of the pull string selected to reduce the risk of a child being able to reach the pull string. In some cases, this objective is achieved by maximizing the height of the lowest point of the pull string when the safety disc is secured. In one embodiment, the safety disc is secured approximately ⅓ of the total length of the pull string from the bottom of the pull string. In other cases, the safety disc is secured to the pull string at a point below ⅓ of the total length of the pull string from the bottom of the pull string. In one embodiment, the safety disc is secured to the pull string approximately 18 inches from the end of the pull string. In one embodiment, the safety disc is secured to the end of the pull string.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. A safety system comprising:
a safety disc attachable to a pull string for a window covering;
a safety anchor;
wherein the safety disc and the safety anchor are adapted to be removable attachable one to another.

2. The safety system of claim 1, wherein:
the safety disc comprises a first hook-and-loop surface;
the safety anchor comprises a second hook-and-loop surface attachable to a wall, a window frame, or a door frame; and
the first hook-and-loop surface and the second first hook-and-loop surface are adapted to removably attach to one another.

3. The safety system of claim 1, wherein:
the safety disc is secured to the pull string and the safety anchor is secured to the wall, the window frame, or the door frame.

4. The safety system of claim 1, wherein the safety disc and the safety anchor are adapted to be removable attachable one to another by magnetic attraction.

5. The safety system of claim 1, wherein:
the safety disc comprises a suction cup and
the safety anchor comprises a window.

6. A method of installing a safety system comprising:
securing a safety disc to a pull string for a window or door covering and
attaching the safety disc to a safety anchor;
wherein the safety disc and the safety anchor are adapted to be removable attachable one to another.

7. The method of claim 6, further comprising securing the safety anchor to a wall near the window or door covering, a window frame, or a door frame.

8. The method of claim 6, wherein:
the safety disc comprises a first hook-and-loop surface;
the safety anchor comprises a second hook-and-loop surface; and
the first hook-and-loop surface and the second first hook-and-loop surface are adapted to removably attach to one another.

9. The method of claim 6, wherein the safety disc and the safety anchor are adapted to be removable attachable one to another by magnetic attraction.

10. The method of claim 6, wherein:
the safety disc comprises a suction cup and
the safety anchor comprises a window.
